(19) United States
(12) Patent Application Publication
(10) Pub. No.: US 2003/0064167 A1
(43) Pub. Date: Apr. 3, 2003

(54) Spray-coating apparatus

(75) Inventor: Felix Mauchle, Abtwil (CH)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ITW Gema AG

(21) Appl. No.: 10/314,356

(22) Filed: Dec. 9, 2002

Related U.S. Application Data
(62) Division of application No. 09/593,297, filed on Jun. 13, 2000.

(30) Foreign Application Priority Data
Jun. 14, 1999 (DE) 199 26 926.2

(51) Int. Cl. B05D 1/04

(52) U.S. Cl. 427/475; 118/663; 118/620; 427/421; 427/8

(57) ABSTRACT

Spray coating apparatus comprising a spray nozzle (2) and a regulation system (16) to limit the high voltage and to limit the current, further to measure the electric spray current of the high-voltage electrode (10).

The invention relates to spray-coating apparatus defined in the preamble of claim 1.

Spray-coating equipment of this sort is known from the European patent document 0,160,179 B1. Through a keypad, an operator applies a desired voltage and a desired electric current that shall be kept constant by a regulation system. A threshold value applies to the distance between the spray equipment and the object to be coated. If the distance exceeds the threshold value, the high voltage at the high-voltage electrode of the spray equipment is kept constant independently of increasing object distance, the electric spray current of the high-voltage electrode decreasing as the object distance increases and increasing as it becomes smaller. When the distance is less than the said threshold value, the electric spray current is kept constant independently of changes in this distance because an increase in current being counteracted by a commensurate drop in voltage. Just before the object comes into contact with the spray equipment, the high voltage collapses entirely (contact protection). The electric current between the electrode and the object to be coated is determined indirectly by measuring the electric current in the primary of a transformer of which the secondary feeds a high-voltage cascaded circuit having rectifiers and capacitors generating the electrode's high DC voltage DC.

U.S. Pat. No. 4,000,443 discloses spray equipment wherein a rise in the electric spray current when an object to be coated nears said equipment is counteracted by a commensurate reduction in the high voltage. The electric spray current is measured indirectly by the current in the secondary between the transformer and the high-voltage cascaded circuit. The European patent document 0,626,208 B1 discusses spray equipment wherein again the input voltage at a high-voltage generator is varied inversely to the current, the electric spray current being measured indirectly as a voltage drop across a resistor preceding the high-voltage electrode. It is known from the British patent 2,077,006 to counteract a rise in the electrode spray current by commensurately reducing the level of the high voltage within a predetermined operational window. U.S. Pat. No. 4,187,527 compares test values of electric spray currents measured in rapid succession when there is a sharp current rise indicating a short, in order to shut off the current.

The European patent document 0,559,608 B1 discloses measuring the current between the high-voltage electrode and the object to be coated using a meter mounted in the electrical path between said object and ground.

The objective of the invention is to solve the problem of preventing the dangers relating to excessively high voltages at the high-voltage electrode when there is a large distance from an electrically conducting object, or an excessively high current, or short, when the object is too near the object, where the object may be something to coat or an operator or something else, and at the same time to design the spray coating apparatus in such manner that optimal coating shall be achieved at minimal energy consumption.

This problem is solved by the invention by means of the combination of features of claim 1.

On account of the feature of claim 1 of a direct measurement of the electric spray current, true test results are provided and rapid response of the regulation system to deviations of instantaneous values from the reference values is achieved.

The sub-claims contain further features of the invention.

In especially advantageous manner of the invention, it contains a counter electrode at a potential substantially differing from that of the high-voltage electrode and for instance at ground in order that free electric particles, in particular that freely wandering ions and electrodes produced by the high-voltage electrode shall be shunted instead of accompanying the spray-coating material from the spray apparatus onto the object to be coated. Counter electrodes are known for instance from the European patent document 0,756,899 A2.

The invention is elucidated below by means of an illustrative embodiment shown in the attached drawings.

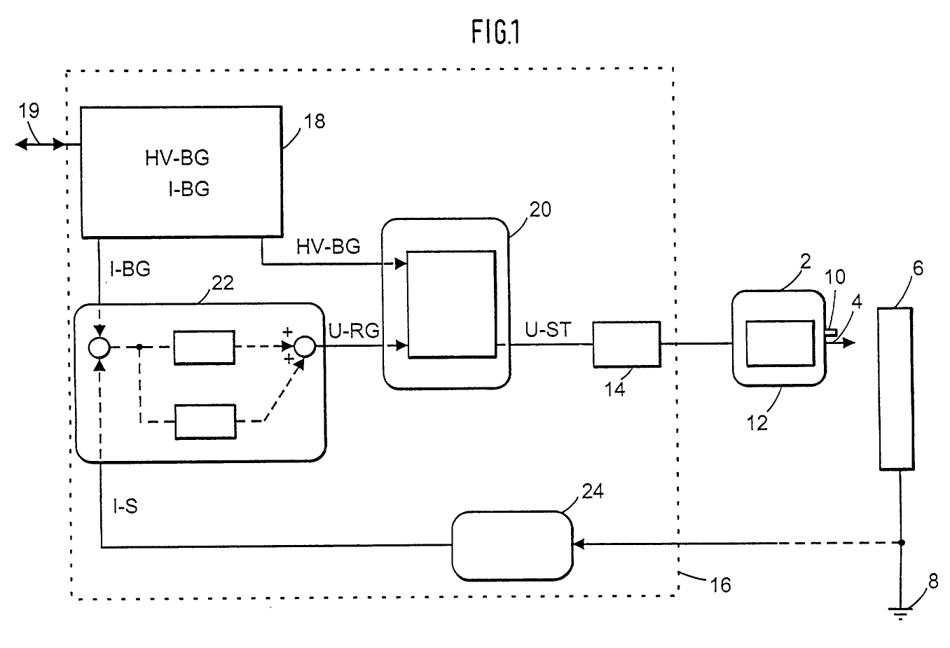

FIG. 1 is a block diagram of the spray coating apparatus of the invention,

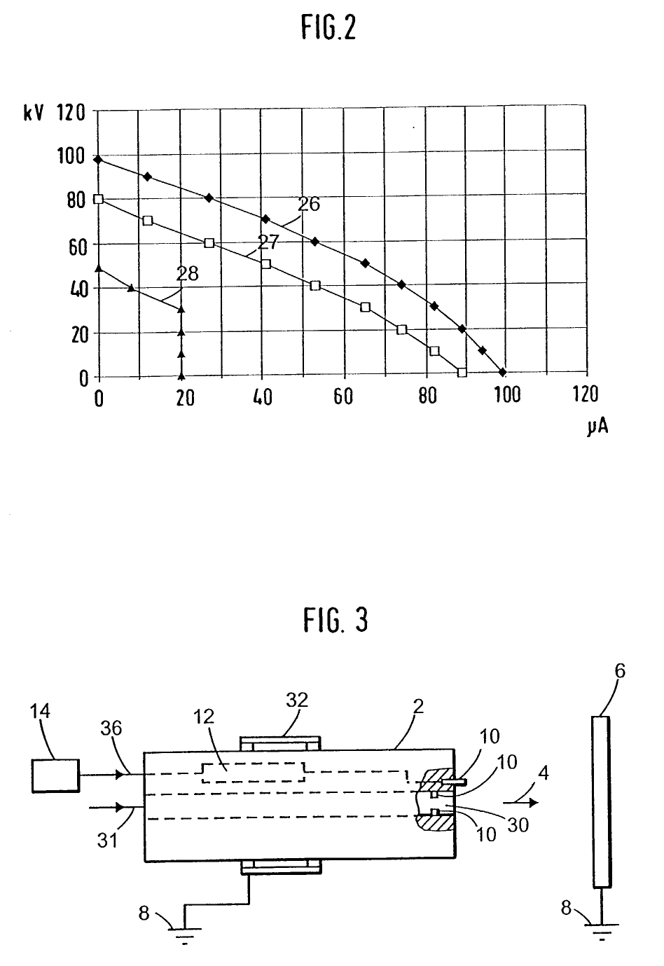

FIG. 2 is a plot of high-voltage vs electric spray current for the spray coating apparatus of FIG. 1, and

FIG. 3 is a diagram of a spray nozzle of the spray coating apparatus of FIG. 1.

The spray-coating apparatus shown in block form in FIG. 1 comprises a spray nozzle 2 to spray a liquid or preferably powder material 4 on an object 6 to be coated. It is assumed that the objects to be coated are electrically conducting and are at ground 8. In automated facilities, the objects 6 are moved by an omitted conveyor past the spray nozzle 2 and in this manner enter a spray jet denoted by the arrow of the coating material 4.

The nozzle 2 is fitted with at least one high-voltage electrode 10 for the purpose of electrostatically charging the coating material 4 and with a high DC voltage source 12 delivering a high DC voltage which is preferably within the range from 1 to 150 kv and is applied to said electrode. The high-voltage source may be a conventional transformer to step up a low AC voltage into a higher one and a cascaded circuit which contains in manner known per se a plurality of rectifiers and capacitors and converts the AC into the high-voltage DC.

The low-voltage AC is generated by an oscillator 14 as a function of a control voltage U-ST controlling the high-voltage applied to the high-voltage electrode 10. The oscillator 14 may be part of the high-voltage source 12 and as such may be integrated into the nozzle 2, or, as shown in FIG. 1, it may be integrated into a control unit which as a whole operates as a regulation system 16.

The regulation system 16 contains an operational-parameter memory 18. At least one variably adjustable high-voltage limit-value HV-BG and at least one electric-spray current limit-value I-BG for the maximum possible values at the high voltage electrode can fed through a data transfer path 19 into said memory 18 and be stored in it. Preferably several such values relating to different operational states, in particular to different objects to be coated and to different spray materials, can be stored in said memory. In another embodiment of the invention, said stored values may be immutably fixed values.

The operational-parameters memory 18 feeds the high-voltage limit value HV-BG into a high-voltage limiting circuit 20. The limiting-value I-BG for the electric spray current is fed from the operational parameters memory 18 to an electric spray current regulator 22.

The electric spray current of the high-voltage electrode 10 from an object to be coated 6 to ground 8 is measured by an electric-spray current circuit 24 on the side of the object 6 connected to ground and is fed also as the instantaneous electric-spray-current value I-S to the electric-spray-current regulator.

The electric-spray-current regulator 22 compares the instantaneous electric-spray current I-S with the electric-spray-current limiting value I-BG and as a function of this comparison generates a high-voltage regulating value U-RG which is applied from the electric-spray current regulator 22 to the high-voltage limiting-circuit 20. Preferably the electric-spray-current regulator 22 is a PI (proportional integral) control.

As a function of the high-voltage limiting value HV-BG and of the high-voltage regulator value U-RG, the high-voltage limiting circuit 20 generates the control voltage U-ST which, in the form of a DC input voltage is fed to the oscillator 14 and represents the high-voltage setpoint for the high-voltage electrode 10.

In the event the high-voltage regulator value U-RG is larger than or equal to the high-voltage limiting value HV-BG, the high-voltage limiting circuit 20 assures that the DC value of the control voltage U-ST shall be equal to the high-voltage limiting value HV-BG. Moreover the high-voltage limiting circuit 20 assures that, in all cases of the high-voltage regulator value URG being smaller than the high-voltage limiting value HV-BG, the control voltage U-ST shall be equal to the high-voltage regulator value U-RG. These constraints may be stated as follows:

when U-RG≧HV-BG

then U-ST=HV-BG

otherwise U-ST=U-RG.

FIG. 2. shows the electric spray current in μa on the abscissa and the corresponding high voltage in kv on the ordinate. The top function 26 [solid squares] is a standard characteristic line. It shows that in known equipment the electric spray current of the high-voltage electrode rises as the distance between said electrode 10 and object 6 to be coated decreases and how the high-voltage at the same time drops. The high voltage is at its maximum at the largest possible distance away, ie at infinity, of the object 6 to be coated, or another electrically conducting object, from the high-voltage electrode 10.

The center curve 27 [empty squares] relates to an embodiment wherein the maximum DC high voltage of the high-voltage electrode 10 is limited to a maximum value HV-GB of 80 kv, no current limitation I-BG taking place.

The lowermost curve 28 [solid triangles] will materialize in the above circuit of the invention when both the high voltage and the electric spray current are limited to a maximum value each. It was assumes in FIG. 2 that the high-voltage limiting value HV-BG is 50 kv and the electric-spray current limiting value I-BG is 20 μa (20×10⁻⁶ a).

The nozzle 2 is shown is somewhat greater detail in FIG. 3. It shows that one or more high-voltage electrodes can be mounted outside or inside a coating-material duct 30. This duct 30 is loaded with coating material, for instance a coating powder, through a line 31, for instance a hose.

As shown by FIG. 3, the spray nozzle 2 can be fitted with mating electrodes 32 (shunt electrodes) which collect free electrical charges (electrons, ions) discharged from the electrodes 10 and shunt them to ground. It was observed that substantially fewer free electric particles, in particular free ions, are generated in the invention, and that accordingly there is also smaller current leakage.

In FIG. 3 the oscillator 14 is connected by an electric cable 36 to the high-voltage source 12 integrated into the nozzle 2, though it also may be mounted separately from said nozzle, for instance in the regulator system 16.

1. A spray-coating apparatus comprising a spray nozzle (2) to spray coating material onto objects to be coated, further a high-voltage source (12) to apply a high voltage to at least one high-voltage electrode (10) of the spray nozzle (2), also a regulation system (16) to regulate an electric spray current coincident with the coating material from the high-voltage electrode to an object to be coated, the electric spray current being automatically measured by an electric-spray current circuit (24) and a rise in current being opposed by a reduction in voltage, and means (18, 20, 22) to limit the electric current and the high-voltage each to a predetermined value,
characterized in that the electric spray-current measuring-circuit (24) is mounted in the return path of the electric current from the object (6) to be coated back into the regulation system (16) in order to measure therein the electric spray current.

2. Spray coating apparatus as claimed in claim 1, characterized in that the electric current return path is connected to ground (8).

3. Spray coating apparatus as claimed in either of claims 1 and 2, characterized in that the electric current limiting value and/or the high-voltage limiting value is variably adjustable.

4. Spray coating apparatus as claimed in one of the above claims, characterized in that it comprises a memory (18) to store at least one electric current limiting value (I-BG) and at least one high-voltage limiting value (HV-BG), said limiting values being variably adjustable.

5. Spray coating apparatus as claimed in one of the above claims, characterized in that at least one counter electrode (32) at a potential strongly different from the potential of the high-voltage electrode (10) is configured at the spray nozzle (2) at a distance from the high-voltage electrode (10) and outside the flow of coating material in order to shunt free ions and free electrons generated by the high voltage electrode (10), where said ions and electrons however do not move together with the coating material onto the object to be coated.
